(19) United States
(12) Patent Application Publication
(10) Pub. No.: US 2026/0131824 A1
(43) Pub. Date: May 14, 2026

(54) REAL TIME COMPATIBILITY OF ARTIFICIAL INTELLIGENCE MODELS WITH REGULATION SCENARIOS FOR DRIVING

(71) Applicant: AUTOBRAINS TECHNOLOGIES LTD, Tel Aviv-Yafo (IL)

(72) Inventors: Igal RAICHELGAUZ, Tel Aviv (IL); Ido COHEN, Tel Aviv-Yafo (IL)

(73) Assignee: AUTOBRAINS TECHNOLOGIES LTD, Tel Aviv-Yafo (IL)

(21) Appl. No.: 18/946,998

(22) Filed: Nov. 14, 2024

(51) Int. Cl. B60W 60/00

(52) U.S. Cl. CPC B60W 60/0011

(57) ABSTRACT

A method for real time compatibility of artificial intelligence models with regulation scenarios, the method includes selecting, in view of environmental information relating to an initial indication of a driving scenario faced by a vehicle, at least a first artificial intelligence model, to provide an initial driving decision making in accordance with the driving scenario; determining, based on additional incoming data captured in a driving of the vehicle towards the driving scenario, a current indication of the driving scenario faced by the vehicle; and selecting, in real-time and based on the determined current indication, at least a second artificial intelligence model to provide a second driving decision making in accordance with both the initial indication of the driving scenario and the current indication of the driving scenario.

### BACKGROUND

Vehicles include machine learning processes that are trained to cope with different scenarios.

Various regulations, such as the New Car Assessment Programme (NCAP), impose strict requirements regarding the accuracy of the output of machine learning process used in vehicles.

There is a growing need to provide accurate machine learning processes.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a computerized system;

FIG. 2 illustrates examples of a method;

FIG. 3 illustrates an example of an activation process of artificial intelligence (AI) models;

FIG. 4 illustrates an example of a scenario;

FIG. 5 illustrates an example of a scenario;

FIG. 6 illustrates an example of a scenario; and

FIG. 7 illustrates an example of a scenario.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

The term obtaining include receiving and/or generating.

Artificial intelligence is used in relation to machines that mimic human intelligence and human cognitive functions like learning and problem solving. There are three types of artificial intelligence that include artificial super intelligence, artificial narrow intelligence and artificial general intelligence. Machine learning is a subset of artificial intelligence that allows for optimization. Deep machine learning is a subset of machine learning that uses larger datasets for training and learns in a different manner than not deep machine learning. Neural networks are a subset of machine learning and are used for implementing deep learning.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example—any reference to a neural network should be applied mutatis mutandis to artificial intelligence and/or should be applied mutatis mutandis to “machine learning”, and/or should be applied mutatis mutandis to “deep learning”.

According to an embodiment a scenario includes at least one of (a) a location of the vehicle, (b) one or more weather conditions, (c) one or more contextual parameters, (d) a road condition, (e) a traffic parameter. Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information—context may be depending on or relating to the circumstances that form the setting for an event, statement, or idea.

According to an embodiment, there is provided a method for real time compatibility of artificial intelligence models with regulation scenarios for driving. The method provides an accurate decision making in relation to a driving scenario that is only partially known at a certain point of time, and where additional information regarding the driving scenarios are known when further approaching the driving scenario.

According to an embodiment, the method effectively transition from receiving an initial indication to receiving a current indication of the driving scenario faced by the vehicle. The method selectively and dynamically updates, in real time, its response to the reception of more information about a driving scenario and fine tunes the decisions related to the driving of the vehicle accordingly.

According to an embodiment, the method uses a cache memory to speed up the execution of the method.

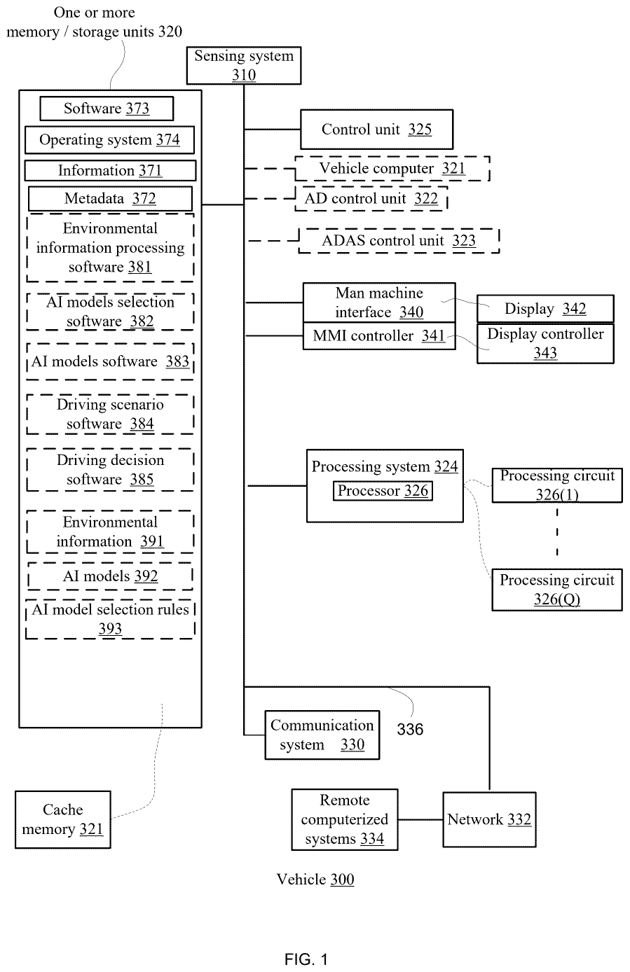

FIG. 1 illustrates an example of vehicle 300.

Vehicle 300 includes a man machine interface 340 having or being in communication with man machine interface (MMI) controller 341, wherein in FIG. 1 the MMI is a display 342 or includes a display 342 and the MMI controller is a display controller 343 or includes the display controller 343, a communication system 330, one or more memory and/or storage units 320, a processing system 324 including processor 326. The communication system 330, the one or more memory and/or storage units 320, and the processing system 324 may belong to a computerized system of vehicle 300. The computerized system may be a server, a laptop, a desktop or any other computer and may include or be in communication with a sensing unit and/or a controller.

According to an embodiment, vehicle 300 is in communication with network 332 and one or more other remote computerized systems 334 that are in communication with network 332. An example of a remote computerized system is a server or one or more computers having access to a storage system that stores items related to one or more portions of one or more groups of neural networks—at least some of which are not currently stored in the vehicle.

According to an embodiment, network 332 is located outside the computerized system and is used for communication between the computerized system and at least one remote computing system and/or one or more vehicles. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 330) which can be implemented in both wired and wireless environments. Such networking environments are conventional and commonplace in offices, enterprise-wide computer networks, intranets, and a larger network such as the internet. It should be noted that at least a part of the content illustrated as being stored in one or more memory/storage units 320 may be stored outside the computerized system. It should also be noted that the processor may evaluate signatures generated by a plurality of detectors.

According to an embodiment, the communication system 330 is configured to enable communication between the one or more memory and/or storage units 320 and/or any one of the additional units and/or the network 332 (that is in communication with the remote computerized systems). Communication system 330 is also configured to enable communication with other elements such as sensing system 310, man machine interface 340, control unit 325, vehicle computer 321, autonomous driving control unit 322 (denoted AD control unit), advanced driver assistance system (ADAS) control unit 323 (denoted ADAS control unit), and the like.

The memory and/or storage units 320 was shown as storing software. Any reference to software should be applied mutatis mutandis to code and/or firmware and/or instructions and/or commands, and the like.

Processor 326 includes a plurality of processing units 326(1)-326(Q), Q is an integer that exceeds one. Any reference to one unit or item should be applied mutatis mutandis to multiple units or items.

According to an embodiment, the memory and/or storage units 320 stores at least one of: operating system 374, information 371, metadata 372, and software 373.

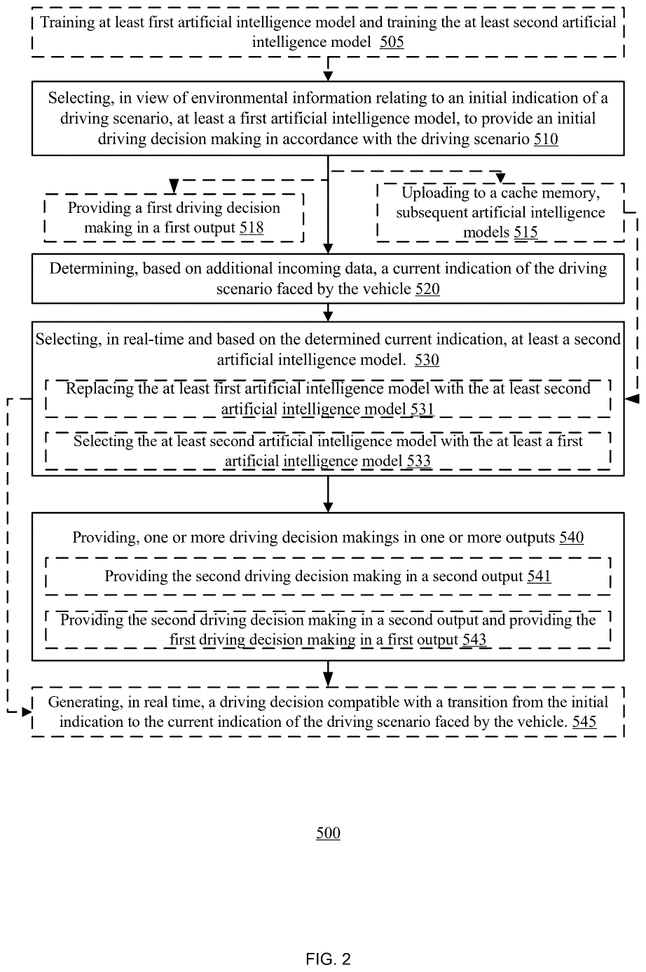

Examples of software include at least one of environmental information processing software 381 (for providing an initial indication of a driving scenario in step 510 of method 500 of FIG. 2 and/or for providing a current indicator of the driving scenario in step 530 of method 500), AI model selection software 382 (for executing step 510 and/or step 530 of method 500), AI models software 383 (for implementing AI models such as the at least first AI model of step 510 and/or the at least second AI model of step 530 of method 500), driving scenario software 384 (for providing the initial indication of the driving scenario of step 510 and/or for executing step 520 of method 500), driving decision software 385 (for executing step 545 of method 500). Only one or some of these software may be stored in the one or more memory/storage units 320. There may be at least partial overlaps between one software to the other.

Examples of information and/or metadata include at least one of environmental information 391, AI models 392, AI model selection rules 393 executable by the perception router. Only one or some of these information and/or metadata may be stored in the one or more memory/storage units 320.

FIG. 1 also illustrates an example of a cache memory 321 that belongs to the one or more memory/storage units 320.

The control unit 325 may cooperate with ADAS control unit 323 and/or with AD control unit 322 and/or may control or communicate with other vehicle components—including vehicle computer.

The ADAS control unit 323 is configured to control ADAS operations.

The AD control unit 322 is configured to control autonomous driving of the autonomous vehicle.

The vehicle computer 321 is configured to control the operation of the vehicle-especially controlling the engine, the transmission, and any other vehicle system or component.

The vehicle computer 321 may be in communication with an engine control module, a transmission control module, a powertrain control module, and the like.

The sensing system 310 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 310 is configured to output environmental information—for example in the form of one or more sensed information units (SIUs).

Control unit 325 is configured to control the operation of the sensing system 310, and/or the one or more memory and/or storage units 320 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database such as any database known in the art.

Various units and/or components are in communication with each other using any communication elements and/or protocols. An example of a communication system is denoted 330. Other communication elements may be provided.

According to an embodiment, processing system 324 is configured to perform method 600, while executing software.

According to an embodiment, processing system 324 is configured to perform, while executing software:
Select, in view of environmental information relating to an initial indication of a driving scenario faced by a vehicle, at least a first artificial intelligence model, to provide an initial driving decision making in accordance with the driving scenario.
Determining, based on additional incoming data captured in a driving of the vehicle towards the driving scenario, a current indication of the driving scenario faced by the vehicle.
Select, in real-time and based on the determined current indication, at least a second artificial intelligence model to provide a second driving decision making in accordance with both the initial indication of the driving scenario and the current indication of the driving scenario.

According to an embodiment, processing system 324 is also configured to perform, while executing software, at least one of:
Provide one or more driving decision makings in one or more outputs.
Generate, in real time, a driving decision compatible with a transition from the initial indication to the current indication of the driving scenario faced by the vehicle, based on the first driving decision making and the second driving decision making.
Train the at least first artificial intelligence model to provide the initial driving decision making in accordance with the driving scenario, and training the at least second artificial intelligence model to provide the second driving decision making in accordance with both the initial indication of the driving scenario and the current indication of the driving scenario.

FIG. 2 illustrates method 500 of real time compatibility of artificial intelligence models with regulation scenarios.

According to an embodiment, method 500 includes step 510 of selecting, in view of environmental information relating to an initial indication of a driving scenario faced by a vehicle, at least a first artificial intelligence model, to provide an initial driving decision making in accordance with the driving scenario.

According to an embodiment, the environmental indication information related to the initial indication of the driving scenario provides partial information regarding the driving scenario—and additional incoming information related to the driving scenario will be revealed when the vehicle continues to drive toward the road scenario. For example—the additional information is temporarily obscured or otherwise not currently sensed by one or more sensors associated with the vehicle that are used to generate the environmental indication.

According to an embodiment, step 510 included at least one of:
Obtaining from a sensor associated with the vehicle, the environmental information relating to the initial indication of the driving scenario.
Generating, in a driving of the vehicle, a signature based on the environmental information relating to the initial indication of the driving scenario.
Matching, in the driving of the vehicle, the signature with a set of concept signatures in association with driving scenarios.
Selecting the at least first artificial intelligence model based on an outcome of the matching. A matching set of concept signature is an example of the initial indication of the driving scenario.

According to an embodiment, step 510 is preceded by step 505 of training the at least first artificial intelligence model to provide the initial driving decision making in accordance with the driving scenario, and training the at least second artificial intelligence model to provide the second driving decision making in accordance with both the initial indication of the driving scenario and the current indication of the driving scenario.

According to an embodiment, the training is executed by supervised learning, by unsupervised learning or by self-supervising learning.

According to an embodiment the training included setting a loss function in order to mimic the behavior of one or more vehicles when initially facing the driving scenario and when continuing to drive towards the road scenario and receive the current indication of the driving scenario.

According to an embodiment step 510 is followed by step 515 of uploading to a cache memory, following the selecting of the at least first artificial intelligence model, subsequent artificial intelligence models that are associated with different values of the current indication of the driving scenario. This step increases the speed of execution of method 500—especially when step 530 involves retrieving cached content.

According to an embodiment, subsequent artificial intelligence models represent driving scenarios that are more specific that the driving scenario associated with the at least first artificial intelligence model. For example—the driving scenario associated with the at least first artificial intelligence model is reaching a parking lot, while the subsequent artificial intelligence models represent driving scenarios are associated with a parking lot that is empty, a parking lot that is partially full, a parking lot that includes pedestrians, a parking lot that includes parked vehicles and one or more bicycles, and the like.

According to an embodiment, step 510 is followed by step 520 of determining, based on additional incoming data captured in a driving of the vehicle towards the driving scenario, a current indication of the driving scenario faced by the vehicle.

The current indication of the driving scenario is expected to be more accurate (alone or in combination with the initial indication) than the initial indication.

According to an embodiment, step 520 is followed by step 530 of selecting, in real-time and based on the determined current indication, at least a second artificial intelligence model to provide a second driving decision making in accordance with both the initial indication of the driving scenario and the current indication of the driving scenario.

According to an embodiment the additional incoming data is an additional environmental information.

According to an embodiment, the environmental information is sensed by one or more sensors related to a vehicle. A sensor related to a vehicle may belong to the vehicle, may be attached to the vehicle, may be spaced apart from the vehicle, may follow a movement of the vehicle, may not follow the movement of the vehicle, may be an aerial sensor, a satellite sensor, an airborne sensor, a ground sensor, and the like.

According to an embodiment, any sensor of the one or more sensors related to the one or more vehicles may be at least one of an image sensor, a non-image sensor, a visible light sensor, a sensor operating in one or more frequencies other than visible light, a radar, a sonar, a magnetometer, a LIDAR, an ultrasonic sensor, an infrared sensor, a near infrared sensor, a radiometer, a thermal sensor, a microwave sensor, a x-ray sensor, a gravitometer, an altimeter, a barometer, a synthetic-aperture radar, a monochromatic sensor, a passive sensor, an active sensor, and the like.

According to an embodiment, step 530 included at least one of:
Obtaining from a sensor associated with the vehicle, the environmental information relating to the current indication of the driving scenario.
Generating, in a driving of the vehicle, a signature based on the environmental information relating to the current indication of the driving scenario.
Matching, in the driving of the vehicle, the signature with a set of concept signatures in association with driving scenarios.
Selecting the at least second artificial intelligence model based on an outcome of the matching. A matching concept signature is an example of the current indication of the driving scenario.

According to an embodiment, step 530 includes step 531 of replacing the at least first artificial intelligence model with the at least second artificial intelligence model.

According to an embodiment, step 530 includes step 533 of selecting the at least second artificial intelligence model with the at least a first artificial intelligence model.

According to an embodiment, step 510 and/or step 530 are executed by a perception router. Examples of a perception router are illustrated in U.S. patent application Ser. No. 18/459,414 titled “Perception based driving”, and U.S. patent application Ser. No. 18/036,150 titled “Ensemble of narrow AI agents for vehicles”, all being incorporated herein by reference.

According to an embodiment, the driving scenario is associated with a group of parameters that includes two or more out of (a) the location of the vehicle, (b) one or more weather conditions, (c) one or more contextual parameters, (d) a road condition, and (e) a traffic parameter.

According to an embodiment, the initial indication of the driving scenario is related to only a sub-group of the group of parameters, while the current indication of the driving scenario is also related to one of more parameters of the group not included in the sub-group.

According to an embodiment, step 530 is also preceded by step 515 and the selected at least a second artificial intelligence model is fetched from the cache memory.

According to an embodiment, step 530 are followed by step 540 of providing, one or more driving decision makings in one or more outputs.

According to an embodiment, step 540 includes step 541 of providing, by the at least second artificial intelligence model, the second driving decision making in a second output. Step 541 is preceded by step 531. According to an embodiment, the selecting of the at least the second artificial intelligence model is to provide the second driving decision making as a fine tuned version of the first driving decision making.

According to an embodiment, step 540 includes step 543 of providing, by the at least second artificial intelligence model, the second driving decision making in a second output, and providing, by the at least first artificial intelligence model, the initial driving decision making in a first output. Step 543 is preceded by step 533.

According to an embodiment, step 530 is followed by step 545 of generating, in real time, a driving decision compatible with a transition from the initial indication to the current indication of the driving scenario faced by the vehicle, based on the first driving decision making and the second driving decision making.

According to an embodiment, step 545 is executed by an output unit that follows the at least first artificial intelligence model and/or from the at least second artificial intelligence model. According to an embodiment, an example of an output unit (referred to as a coordinator) is illustrated in U.S. patent application Ser. No. 18/036,150 which is incorporated herein by reference. According to an embodiment, an example of an output unit (referred to as a driving decision unit) is illustrated in U.S. patent application Ser. No. 18/036,150 which is incorporated herein by reference.

According to an embodiment, step 545 includes receiving by the output unit, outputs from the at least first artificial intelligence model and/or from the at least second artificial intelligence model, and outputting by the output unit, one or more output driving outputs.

According to an embodiment, step 545 included applying, by the output unit, any process for generating one or more output driving decisions such as the one or more commands and requests based on the outputs from the at least first artificial intelligence model and/or from the at least second artificial intelligence model. According to an embodiment, step 545 includes applying at least one of arbitration, competition, selecting a response based on a risk imposed by adopting an output of the at least first artificial intelligence model and/or from the at least second artificial intelligence model, and the like.

According to an embodiment, the driving related output is used by an advanced driver assistance system (ADAS) related to the vehicle.

According to an embodiment, the driving related output includes at least one of:
An instruction executable by a man machine interface controller, to provide a recommendation to a driver regarding a navigation of the vehicle.
A request aimed to the man machine interface controller, to provide a recommendation to a driver regarding a navigation of the vehicle.
An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
An instruction executable by a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
A request aimed to a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
An instruction executable by a computer vehicle related to a manner of operation of any component of the vehicle such as brakes, engine, and the like.
A request sent to a computer vehicle related to a manner of operation of any component of the vehicle such as brakes, engine, and the like.

Information about the environment of the vehicle.
A prediction of a future path of the vehicle.
A prediction of a behavior of one or more road element.
An emergency alert.
A collision alert.

According to an embodiment, the method includes outputting and/or transmitting an/or storing and/or instructing to respond to and/or triggering a response to and/or controlling a response to and/or performing a respond to any of the driving related output listed above and/or below.

According to an embodiment, the method includes generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment and/or in the environment with re to the vehicle, an operation and/or response in compliant with one or more levels of autonomous driving—such as L2, L2+, L2++, L3 or L4 autonomous driving.

The providing of the driving related output may include storing the driving related output at a location accessible to another unit controller, transmitting instructions of the driving related output to the other unit, sending an indication about the generation of the instructions of the driving related output to the other unit man machine interface controller.

According to an embodiment, the method may include outputting and/or transmitting an/or storing and/or instructing to respond to and/or triggering a response to and/or controlling a response to and/or performing a respond to any of the driving related output listed above and/or below.

According to an embodiment, step 510 is also followed by step 518 of providing, (at least during the time gap between the execution of step 510 and step 540) by the at least first artificial intelligence model, the initial driving decision making in a first output.

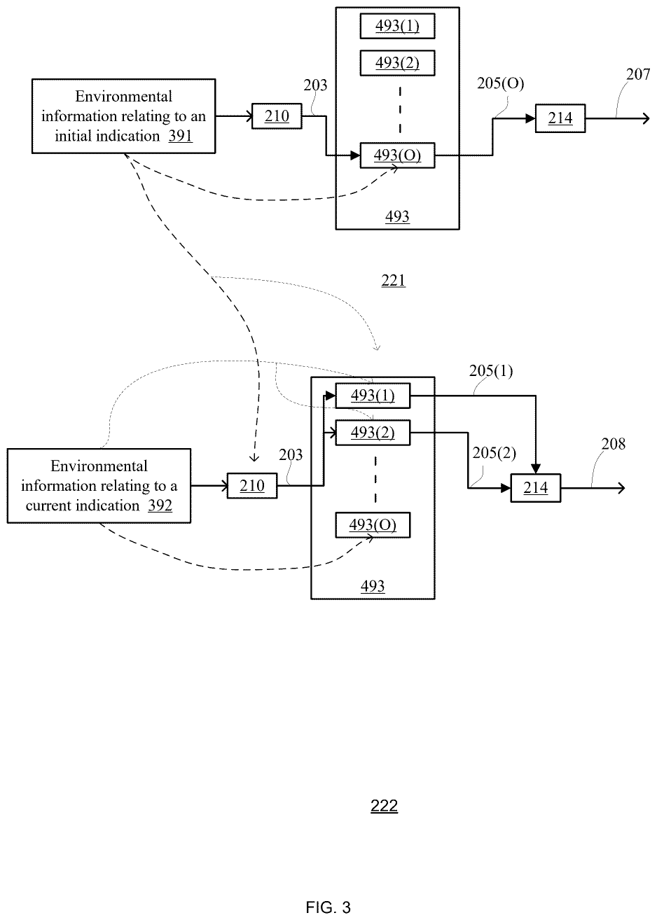

FIG. 3 illustrates a first example 221 that is related steps 510 and 518, and a second example 222 that is related to steps 510, 530 and 540.

In the first example 221, environmental information relating to an initial indication 391 is fed to perception router 210 that in turn selects first AI model 493(O). The selection is following by activation indication 203 for activating the first AI model 493(O). The first AI model 493(O) is fed with the environmental information relating to an initial indication 391 and provides a first decision making 205(O) to the output unit 214 that in turn outputs a driving decision 207.

In the second example 222, the environmental information relating to the initial indication 391 and the environmental information relating to the current indication 392 are fed to perception router 210 that in turn selects second AI models 493(1) and 493(2). The selection is following by activation indication 203 for activating second AI models 493(1) and 493(2). The second AI models 493(1) and 493(2) are fed with the environmental information relating to an initial indication 391 and with the environmental information relating to the current indication 392 and provides second decision making 205(1) and 205(2) to the output unit 214 that in turn outputs a driving decision 208.

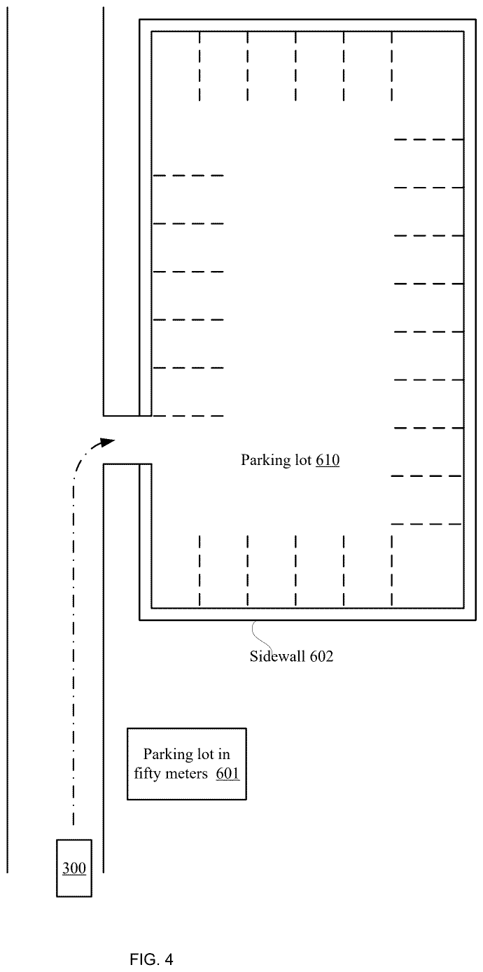

FIGS. 4-7 illustrate examples of driving scenes related to a vehicle 300 that approaches a parking lot 610 that is surrounded by sidewall 602 and preceded by a advertisement board 601 “Parking lot in fifty meters”. The content of the parking lot is not visible to the vehicle till the vehicle enters the parking lot or at least faces in front of the opening to the parking lot.

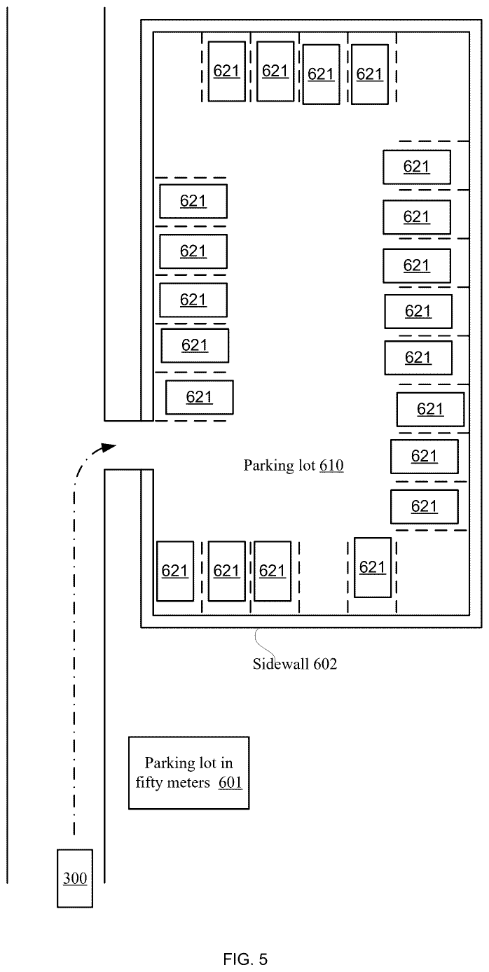

In FIG. 4 the parking lot 610 is empty. In FIG. 5 the parking lot is almost fully populated by parking vehicles that properly park within the parking slots of the parking lot.

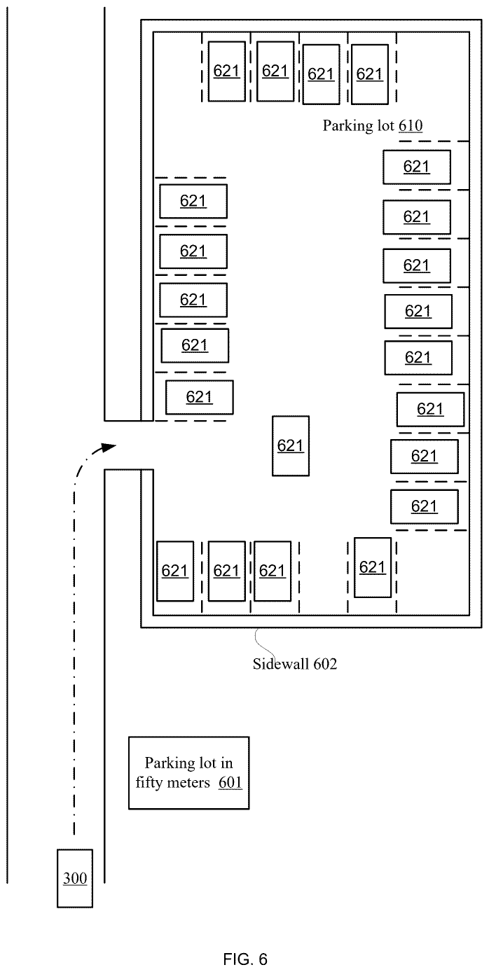

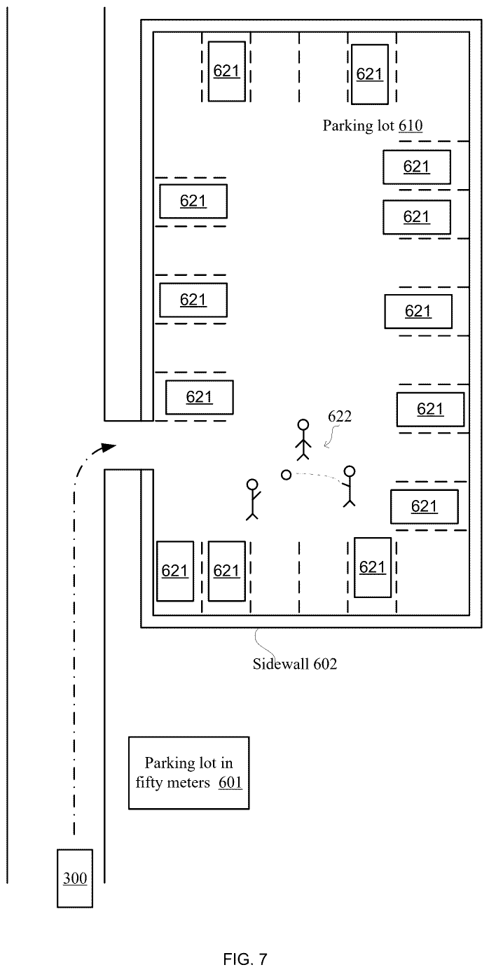

In FIG. 6 the parking lot 610 is almost fully populated by parking vehicles-one of which is parked outside the parking slots and partially blocks access to one or more parking slots. In FIG. 7 the parking lot 610 is only partially populated parking vehicles that properly park within the parking slots of the parking lot, but children 622 play ball within the parking lot.

FIG. 4 till 7 illustrate different scenarios—all associated with a parking lot. In step 510 the environmental information is indicative of the presence of the parking lot. In step 520 the additional information is indicative of one of the scenarios of FIG. 4 till 7—and a better driving decision is made once the additional information is provided.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim

1. A method of real time compatibility of artificial intelligence models with regulation scenarios, comprising:
selecting, in view of environmental information relating to an initial indication of a driving scenario faced by a vehicle, at least a first artificial intelligence model, to provide an initial driving decision making in accordance with the driving scenario;
determining, based on additional incoming data captured in a driving of the vehicle towards the driving scenario, a current indication of the driving scenario faced by the vehicle; and
selecting, in real-time and based on the determined current indication, at least a second artificial intelligence model to provide a second driving decision making in accordance with both the initial indication of the driving scenario and the current indication of the driving scenario.

2. The method according to claim 1, wherein the selecting involves replacing the at least first artificial intelligence model with the at least second artificial intelligence model.

3. The method according to claim 1, wherein the selecting involves selecting the at least second artificial intelligence model with the at least a first artificial intelligence model.

4. The method according to claim 3, further comprising:
providing, by the at least first artificial intelligence model, the initial driving decision making in a first output; and
providing, by the at least second artificial intelligence model, the second driving decision making in a second output.

5. The method according to claim 1, further comprising generating, in real time, a driving decision compatible with a transition from the initial indication to the current indication of the driving scenario faced by the vehicle, based on the first driving decision making and the second driving decision making.

6. The method according to claim 1, wherein the selecting of the at least the second artificial intelligence model is to provide the second driving decision making as a fine tuned version of the first driving decision making.

7. The method according to claim 1, further comprising uploading to a cache memory, following the selecting of the at least first artificial intelligence model, subsequent artificial intelligence models that are associated with different values of the current indication of the driving scenario.

8. The method according to claim 1, further comprising:
training the at least first artificial intelligence model to provide the initial driving decision making in accordance with the driving scenario; and
training the at least second artificial intelligence model to provide the second driving decision making in accordance with both the initial indication of the driving scenario and the current indication of the driving scenario.

9. A non-transitory computer readable medium for real time compatibility of artificial intelligence models with regulation scenarios, the non-transitory computer readable medium storing instructions that, when executable by at least one processing device, cause the at least one processing device to:
select, in view of environmental information relating to an initial indication of a driving scenario faced by a vehicle, at least a first artificial intelligence model, to provide an initial driving decision making in accordance with the driving scenario;
determine, based on additional incoming data captured in a driving of the vehicle towards the driving scenario, a current indication of the driving scenario faced by the vehicle; and
select, in real-time and based on the determined current indication, at least a second artificial intelligence model to provide a second driving decision making in accordance with both the initial indication of the driving scenario and the current indication of the driving scenario.

10. The non-transitory computer readable medium according to claim 9, wherein the at least one processing device selects the at least second artificial intelligence model by replacing the at least first artificial intelligence model with the at least second artificial intelligence model.

11. The non-transitory computer readable medium according to claim 9, wherein the at least one processing device selects the at least second artificial intelligence model with the at least first artificial intelligence model.

12. The non-transitory computer readable medium according to claim 11, further storing instructions that, when executable by the at least one processing device, cause the at least one processing device to:
provide, by the at least first artificial intelligence model, the initial driving decision making in a first output; and
provide, by the at least second artificial intelligence model, the second driving decision making in a second output.

13. The non-transitory computer readable medium according to claim 9, further storing instructions that, when executable by the at least one processing device, cause the at least one processing device to generate, in real time, a driving decision compatible with a transition from the initial indication to the current indication of the driving scenario faced by the vehicle, based on the first driving decision making and the second driving decision making.

14. The non-transitory computer readable medium according to claim 9, wherein the at least second artificial intelligence model provides the second driving decision making as a fine tuned version of the first driving decision making.

15. The non-transitory computer readable medium according to claim 9, further storing instructions that, when executable by the at least one processing device, cause the at least one processing device to upload to a cache memory, based on the at least first artificial intelligence model, subsequent artificial intelligence models that are associated with different values of the current indication of the driving scenario.

16. The non-transitory computer readable medium according to claim 9, further storing instructions that, when executable by the at least one processing device, cause the at least one processing device to:
train the at least first artificial intelligence model to provide the initial driving decision making in accordance with the driving scenario; and
train the at least second artificial intelligence model to provide the second driving decision making in accordance with both the initial indication of the driving scenario and the current indication of the driving scenario.
